(19) United States
(12) Patent Application Publication
(10) Pub. No.: US 2007/0200310 A1
(43) Pub. Date: Aug. 30, 2007

(54) Hand truck with foot actuated ejection mechanism

(76) Inventor: William A. Dutro, Logan, UT (US)

Correspondence Address: ZIMMERMAN & CRONEN, LLP, 1330 BROADWAY, SUITE 710, OAKLAND, CA, 94612-2506, US

(21) Appl. No.: 11/364,648

(22) Filed: Feb. 27, 2006

(51) Int. Cl. B62B 1/00

(52) U.S. Cl. 280/47.29

(57) ABSTRACT

A hand truck provided with an ejector mechanism which includes a pusher carried by the truck frame and, when actuated, moves forwardly across the truck platform to sweep a load off of the platform. The pusher plate is actuated by a foot actuated pedal or bar. Linkage between the pedal and plate results in response to vertical movement of the pedal. The ejector mechanism may be added into a number of hand trucks already in the field, or may be incorporated in newly produced trucks.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to hand trucks, and more particularly to hand trucks having a load ejecting mechanism, such as a pusher plate or kick-off device to assist in removing a load carried by the hand truck.

2. Description of Related Art

The use of hand trucks for transporting goods, such as from a vehicle loading platform to a particular location in a warehouse or factory, is well known in the art. Typically, such hand trucks include a frame with a pair of ground engaging wheels at its lower end and a load bearing platform adjacent such wheels. In many designs, the under surface of such platform engages the ground during the placing or removing of a load on or from the platform. During movement of the hand truck, the frame, usually engaged adjacent its upper end by the user, is tilted rearwardly so the platform, as well as the frame, will be angularly disposed relative to the ground.

After a load has been moved to its desired position on the floor, it is frequently difficult to remove the box or other load from the hand truck bed or platform on which it is supported. The prior art has suggested various systems for unloading the load from the platform or bed such as by tilting the platform or otherwise arranging for manually actuating a pusher mechanism, typically when the platform is at an angle to the floor. The prior art structures also usually result in a redesign of the hand truck itself.

### BRIEF SUMMARY OF THE INVENTION

In accordance with the teachings of the present invention, the ejection mechanism can be produced as a separate and discrete apparatus which can be added on or attached to a number of different hand trucks, thereby eliminating the necessity of having to change existing hand truck designs and providing an add-on market capability for the product.

A further feature of the present invention results from the fact that the ejection mechanism may be activated when the load bearing platform is resting in a horizontal position on the floor, rather than requiring a tilting of all or a portion of the hand truck.

Another feature of this invention is that the ejection mechanism includes a horizontally movable pusher plate or load kick-off bar movable from a retracted or inoperative position adjacent the truck frame at the inner or rear portion of the truck platform across the platform towards the forward portion of the latter, thereby pushing a load off the platform.

A further feature of the present invention is that after actuation of the ejector mechanism, the pusher plate or kick-off bar automatically returns to its retracted inoperative position.

Still another feature of this invention is that the ejector mechanism is actuated by the user's foot when the hand truck is in a fixed position adjacent the area on the floor on which the load is to be deposited.

### BRIEF DESCRIPTION OF THE DRAWINGS

FIG. 1 is a front perspective view of a generally conventional hand truck.

FIG. 2 is a front perspective view similar to FIG. 1 in which the hand truck is shown in dash-dash lines and the ejector mechanism of the present invention is shown operatively installed on the hand truck.

FIG. 3 is a front perspective view of the ejector mechanism.

FIG. 4 is a front perspective view of the lower portion of a hand truck with the ejector mechanism in a retracted inoperative position.

FIG. 5 is a front perspective view similar to FIG. 4, but showing the ejector mechanism in its final forward load ejection position.

FIG. 6 is a side elevational view of a portion of the lower end of a hand truck with the ejection mechanism shown in its retracted inoperative position.

FIG. 7 is a view similar to FIG. 6, but illustrating the parts in their final push-off positions.

FIG. 8 is an exploded perspective view of the apparatus shown in FIGS. 6 and 7.

### DETAILED DESCRIPTION OF THE INVENTION

The ejector mechanism 10 of the present invention is illustrated and will be described in connection with a hand truck 12 on which it may be installed as an add-on to an existing truck, or which may be incorporated as an integral part of the original hand truck assembly.

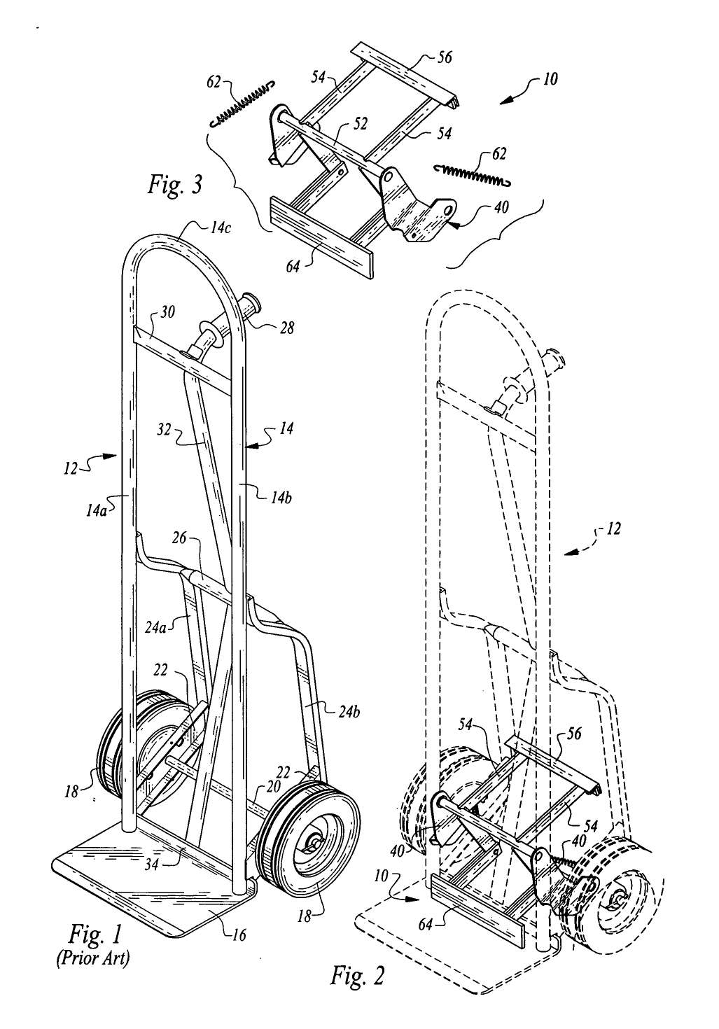

Hand trucks may assume a wide variety of specific shapes and include a number of variations in style and specific functions. However, in connection with the present invention, truck 12 will be described in accordance with its basic structural and functional characteristics. As illustrated in FIG. 1, hand truck 12 includes a main frame 14, and a load bearing platform 16 secured to the lower end of the frame. The plane of frame 14 is normally disposed at right angles to the ground, and platform 16 extends forwardly of and substantially normal to the frame so as to be generally parallel to and supported by the floor or other ground surface on which the truck is placed. When loading or unloading, the frame is disposed generally vertically and the platform generally horizontally.

The truck 12 also includes a pair of ground engaging wheels 18 rotatably mounted on a shaft 20 disposed rearwardly of and generally parallel to the rear edge of platform 16. The shaft is supported on a pair of spaced brackets 22 whose forward ends are welded or otherwise secured to the lower rear portion of spaced legs 14a and 14b of the frame 14. The legs 14a and 14b terminate at their upper ends with an arcuate top frame portion 14c which may serve as a manually engageable handle or grip for maneuvering the hand truck.

The rearward ends of brackets 22 are welded or otherwise secured to supplemental frame members 24a and 24b disposed rearwardly of and generally aligned with frame members 14a and 14b. The upper ends of members 24a and 24b are curved forwardly and secured to medial portions of member 14a and 14b. To compete the frame structure, a crossbar 26 extends between and is secured to member 24a and 24b to add rigidity to the structure.

In addition to the use of frame portion 14c as a handle, a further handle 28 can be provided by attaching the same to a second crossbar 30 extending between and secured to members 14a and 14b. The handle 28 is secured to a generally vertically disposed frame element 32 which extends downwardly and rearwardly and is secured to cross bar 26, and then is angled downwardly and forwardly with the lower end of element 32 secured to a medial position of a web or lip 34 comprising the rearmost edge of platform 16. It may be noted that the shaft 20 is generally equidistant from frame members 14 and 24.

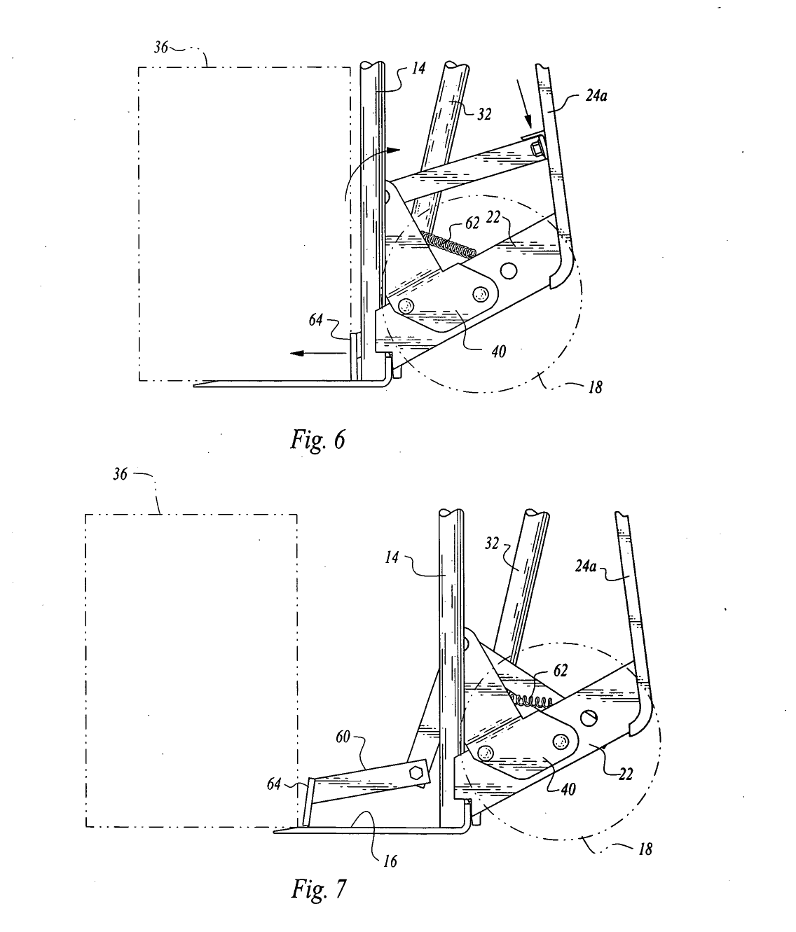

With the foregoing explanation, it should be understood that a typical procedure would be to have a user manually engage arcuate frame portion 14c and/or handle 18, and tilt the truck rearwardly so as to lift the platform away from the floor or other ground surface. The user may then maneuver the truck and roll the same to a location adjacent a load, such as a container 36 as illustrated in dash-dot lines in FIGS. 6 and 7. The user can then urge the leading edge of the platform 16 under the load or can lift the load and place it on the platform, preferably with the lower rear edge portion of the load placed against lip 24 and/or the forward surface of frame members 14a and 14b. The user may then tilt or rock the upper end of the truck rearwardly, causing the platform 16 and the load disposed thereon to assume a tilted position and permit the user to roll the truck to a position at which the container 36 or other load on the platform is to be moved off or ejected from the truck platform. It is this step in the process at which the ejection mechanism of the present invention is put into play. At this time, the user has several options. He or she could tilt the truck forwardly attempting to dislodge the container and then moving the truck to the rear. Alternatively, the user could manually pick up the load and remove it from the truck platform. Preferably, and as will be presently described, by using the ejector mechanism, the user may merely step down on an actuator causing a pushing plate or bar to move forwardly over the platform and push the load off of the same.

The ejector mechanism 10, as above explained, is configured to fit and be mounted on a number of different hand trucks previously sold without any provision for assisting in the removal of containers or other loads from platform 16. However, the same mechanism can be incorporated in the original manufacture of the truck.

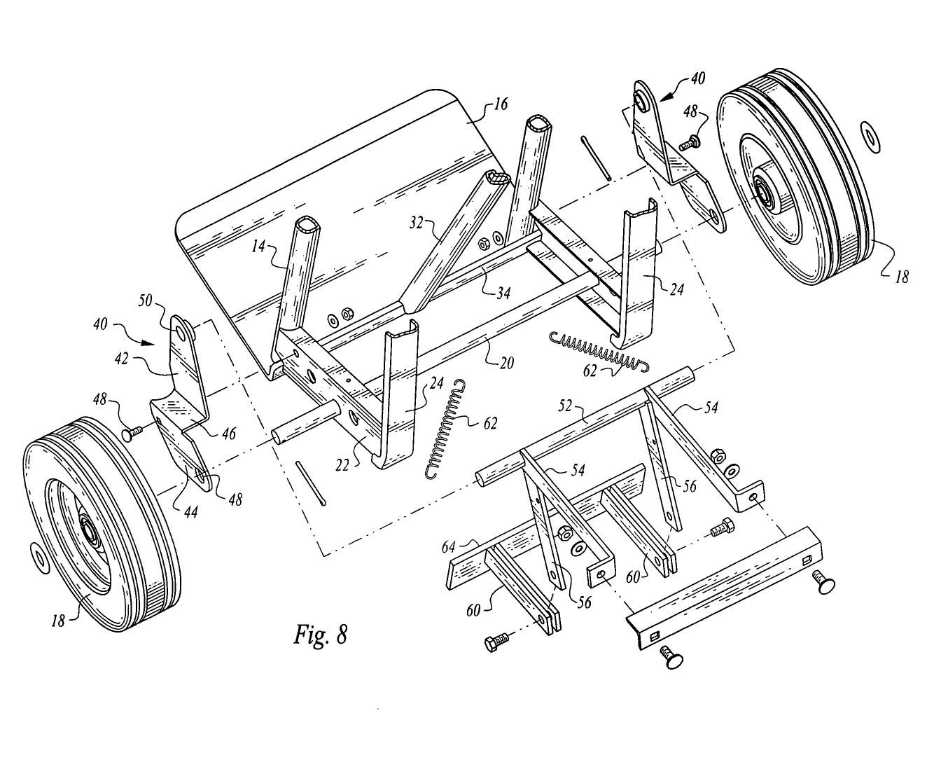

Mounted on shaft 20 intermediate each wheel 18 and its adjacent bracket 22 is a bracket 40. As best seen in FIGS. 3 and 8, the bracket 40 consists of generally flat sheet metal having upper and lower vertically extending and horizontally offset web portions 42 and 44 interconnected by a generally horizontal flange portion 46, defining a generally Z-shaped cross-section. The flange portion is seated at its associated bracket 22 and is secured thereon by machine screws 48 or the like. The lower web portion 44 is provided with an aperture 48 through which shaft 20 extends. Each upper web portion 42 is provided with a bearing 50 for rotatably receiving and supporting a rod 52 capable of rocking oscillatory movements in the bearings. The rod 52 is disposed generally above and parallel to platform lip 34.

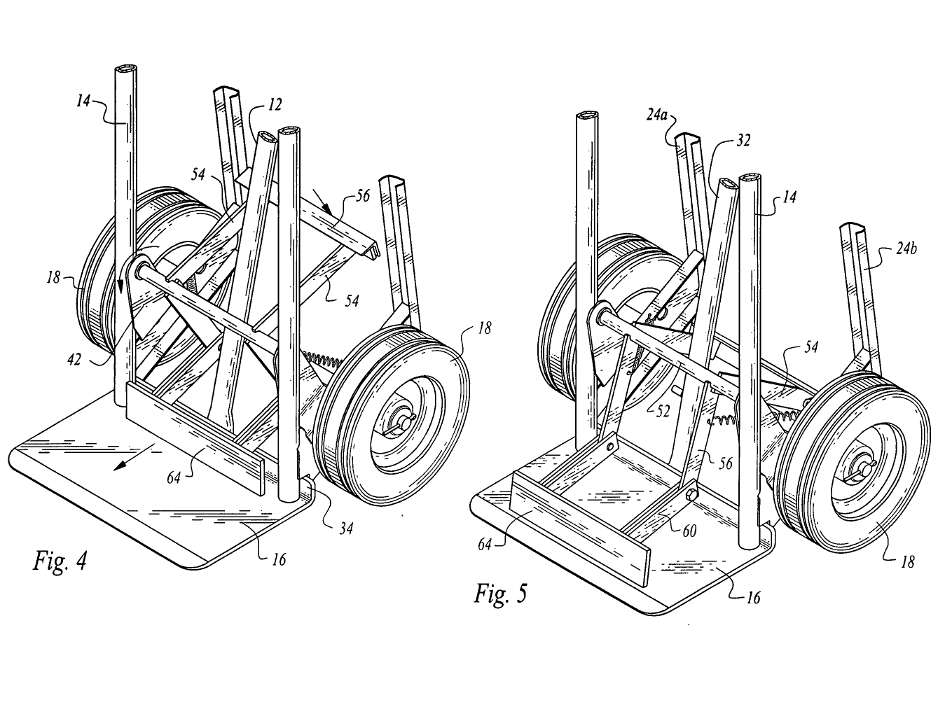

Releasably attached to rod 52 and extending rearwardly therefrom is a pair of laterally spaced arms 54 having distal end portions terminating in a foot engageable actuating bar or pedal 56. Also attached to rod 52 adjacent arms 54 is a pair of generally downwardly extending arms 58 forming a substantial right angle with arms 54. The lower distal end portions of arms 58 are secured to the rear end portions of links 60. Springs 62 connect upper end portions of arms 58 to medial portions of brackets 22. These springs normally urge the parts just described into the inoperative position best shown in FIGS. 2, 4, and 6.

The forward ends of links 60 carry a pusher plate 64 whose normal inoperative position is adjacent the rearmost portion of platform 16. However, as should be apparent from the foregoing description, when a user desires to eject a load from the platform, the frame is placed in its upright position, and the user will step downwardly on actuating bar 56, rocking the members 54, 52, and 56 against the force of springs 62, and cause plate 64 to sweep forwardly over the platform 16 so as to push or eject a load disposed on the platform. This is best shown in FIGS. 5 and 7. When the load is pushed off the platform, the user can release foot pressure, and the springs will bring the parts back to their normal inoperative condition.

1. A load ejection mechanism for use on a hand truck having a generally vertical frame, a pair of ground engaging wheels carried by a lower portion of said frame, a manually engageable handle portion at an upper portion of said frame, and a generally horizontal load supporting platform carried on a lower portion of said frame forwardly of said wheels; said mechanism including an actuating foot pedal, a pusher plate adapted to be normally positioned along a rear edge of such platform, and means supported on such frame interconnecting said pedal and said pusher plate whereby said plate will move forwardly upon depression of said pedal.

2. A mechanism as set forth in claim 1 in which said means is also provided with resilient means for urging said pusher plate to its normal rear position and said foot pedal to a normal raised position.

3. A mechanism as set forth in claim 2 in which said resilient means include a pair of laterally spaced springs each attached at one end to said frame and at the other end to said means.

4. A mechanism as set forth in claim 1 in which said frame includes a first pair of laterally spaced elements, and said means includes a second pair of laterally spaced elements positioned rearwardly of said front pair of laterally spaced elements, said platform being attached to a lower portion of said first pair of laterally spaced elements, a pair of laterally spaced brackets interconnecting said first and second pairs of elements, and springs operatively connected to said brackets and said means for resiliently urging said pusher plate to its rearmost portion overlying said platform.

5. Apparatus as set forth in claim 1 in which said means includes links interconnecting said foot pedal and said pusher plate.

6. A hand truck including a first pair of rigid frame members, a planar load supporting platform secured to the lower ends of said frame members and extending at substantial right angles and forwardly of the plane of said frame members, a pair of secondary frame members lying in a plane rearwardly and substantially parallel to the plane of said first frame members, laterally spaced brackets interconnecting lower end portions of said first and second frame members, a laterally extending shaft mounted on said brackets, ground engaging wheels carried on the ends of said shaft with each wheel disposed laterally outwardly from a respective bracket, a laterally extending rod interposed between said first pair of frame members and capable of oscillation about its axis, a pedal bar interposed between said second pair of frame members, a link member operatively connected to said first links connecting said pedal bar to said rod for oscillating said rod in one direction upon downward movement of said pedal bar, second links on said rod substantially normal to said first links, a pusher plate normally positioned directly over the rear edge of the upper surface of said platform, third links interconnecting said second links to said pusher plate for urging the latter forwardly across said platform upon downward movement of said pedal bar.

7. Apparatus as set forth in claim 6 including at least one tension spring having one end secured to one of said brackets and the other end secured to one of said second links to normally urge said pusher plate into its normal rearward position on said platform.

8. Apparatus as set forth in claim 7 in which a pair of said springs are provided.

9. Apparatus as set forth in claim 6 in which such first, second and third links define a generally Z-shaped configuration.

10. A hand truck for supporting and moving a load comprising a frame having an upper portion and a lower portion, a load bearing platform having a proximal portion secured to a lower portion of said frame, a pusher plate being movable between a first inoperative position disposed adjacent said proximal portion of said platform and a second operative position disposed adjacent a distal portion of said platform, a foot operated pedal bar operatively mounted on said frame and connected to said pusher plate whereby depression of said bar urges said pusher plate towards said operative second position without movement of the frame.

11. Apparatus as set forth in claim 10 including spring means normally urging said pedal bar to its raised position and thereby urging said pusher plate to its first inoperative position.
